(19) United States
(12) Patent Application Publication
(10) Pub. No.: US 2007/0039487 A1
(43) Pub. Date: Feb. 22, 2007

(54) Transporting and cooling device for plasma lava

(75) Inventors: Tsung-Min Hung, Taipei (TW); Ping-Chun Kuo, Pingtung City (TW); Maw-Suey Kuo, Taipei City (TW); Chin-Ching Tzeng, Yonghe City (TW); Deng-Lian Lin, Houbi Township (TW)

Correspondence Address: TROXELL LAW OFFICE PLLC, SUITE 1404, 5205 LEESBURG PIKE, FALLS CHURCH, VA, 22041, US

(73) Assignee: Atomic Energy Council - Institute of Nuclear Energy Research

(21) Appl. No.: 11/205,099

(22) Filed: Aug. 17, 2005

(51) Int. Cl. A23L 3/18

(52) U.S. Cl. 99/470

(57) ABSTRACT

The present invention continuously transports and cools down plasma lava with no gas explosion under an indirect cooling; comprises fewer rotating parts for transportation; prevents radioactive pollutants from escaping out under an air-locked environment; and, avoids motor of transport caravan operating under high temperature, where the present invention can be applied to a plasma melting process for radioactive material.

### FIELD OF THE INVENTION

The present invention relates to a transporting and cooling device; more particularly, relates to transporting a metal bucket to a lava-discharge cooling unit through a transport unit to carry lava, then transporting and cooling down the metal bucket in a cooling tunnel, and then hanging the metal bucket to a storage bucket in a hanging cabinet to be stored, where the present invention can be applied to a plasma melting process for radioactive material.

### DESCRIPTION OF THE RELATED ART

Using plasma with 10000° C. (centigrade) to deal with waste is becoming a mature technology. Because the plasma torch is run under 1650° C. when dealing with the waste, it is required to find ways to discharge and cool down the plasma lava, and to operate a plasma furnace under a negative pressure to prevent off-gas from escaping into the factory building.

As disclosed in Taiwan, “a cooling device for an incinerator with a dust-collecting by a high-pressure spray” comprises a washing section in a high-pressure spray dust-collecting room, a drift eliminator, and a cooling dust-collecting water trough. The washing section is provided with water by a filtering tank through a water inlet. The water in let is connected with U-turn pipes at two ends for gas to pass along an S-type path. At the end of the washing section is the drift eliminator. The drift eliminator comprises a stop per and a dehydration grid, where air is exhausted by an exhaust blower above the dehydration grid. The cooling dust-collecting water trough is located between the washing section and the drift eliminator at the bottom of the high-pressure spray dust-collecting room. By the above structure, the hot gas, dust and water are fully integrated and so the impurity in the air is kept in water and is precipitated. The air exhausted from the drift eliminator is dehydrated by the dehydration grid. In the above cooling device, water is directly in touch with the material to cool it down, so it is not suitable for cooling plasma lava of 1650° C.; especially the plasma lava will be cooled down into grains in lack of radioactive stabilization. So, the prior art does not fulfill users' requests on actual use.

### SUMMARY OF THE INVENTION

Therefore, the main purpose of the present invention is to provide a device for transporting lava and cooling lava continuously, stabilizing plasma lava, and not polluting environment.

To achieve the above purpose, the present invention is a transporting and cooling device for plasma lava, where a metal bucket is hanged to a conveyer by a hanger; the conveyer is driven by an electric motor to transport the metal bucket to a lava-discharge room; an elevating plate in the lava-discharge room lifts the metal bucket and positions it in a cooling jacket to joint with an opening of a plasma furnace for being loaded with plasma lava while the high-temperature plasma lava is cooled down by the cooling jacket; after finishing discharging the plasma lava and sealing the metal bucket with a cover, the metal bucket is remained still for at least 2 hours to be cooled down below 500° C.; the metal bucket is pushed to a carrying track of a cooling tunnel and the cooling tunnel comprises a cooling-water jacket, a cooling-air entrance, an air distribution pipe and a cooling-air exit; the metal bucket is transported seat by seat in a cooling tunnel with a transport caravan to its exit to be positioned and the temperature on the exterior surface of the metal bucket is cooled down to 60° C. during 20 hours by a water cooling system and an air cooling system; the metal bucket is hanged by a positioning hanging device out of the cooling tunnel to be processed with a surface radiation dosage detection, a weight measuring and a recording; and, the metal bucket is hanged to a hanging cabinet to be stored in a storage bucket of 55 gallons sealed with a cover. As a result, the present invention is an air-locked device preventing radioactive pollutants from escaping out; continuously transports and cools down plasma lava without the risk of gas explosion under an indirect cooling; comprises fewer rotating parts for transportation; and, avoids motor of transport caravan being operated under high temperature, where the present invention can be applied to a plasma melting process for radioactive material. Accordingly, a novel transporting and cooling device for plasma lava is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a top view showing a preferred embodiment according to the present invention;

FIG. 2 is a side view showing a transport unit and a lava-discharge cooling unit according to the preferred embodiment of the present invention;

FIG. 3 is a side view showing a transport unit and a storage unit according to the preferred embodiment of the present invention;

FIG. 4a is a view showing an air-cooling system of a cooling tunnel according to the preferred embodiment of the present invention; and

FIG. 4b is a view showing the storage unit according to the preferred embodiment of the present invention.

### DESCRIPTION OF THE PREFERRED EMBODIMENT

The following description of the preferred embodiment is provided to understand the features and the structures of the present invention.

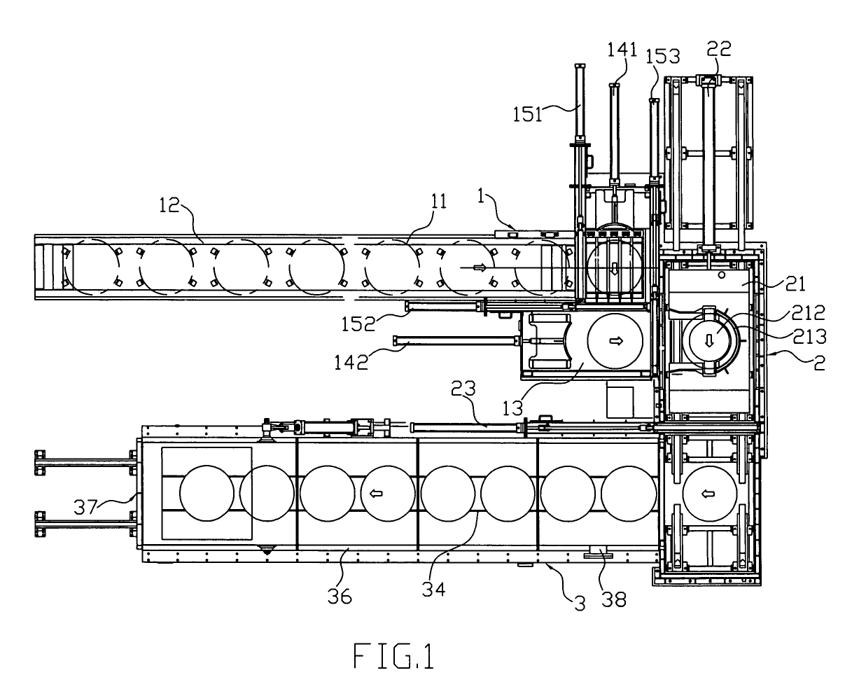

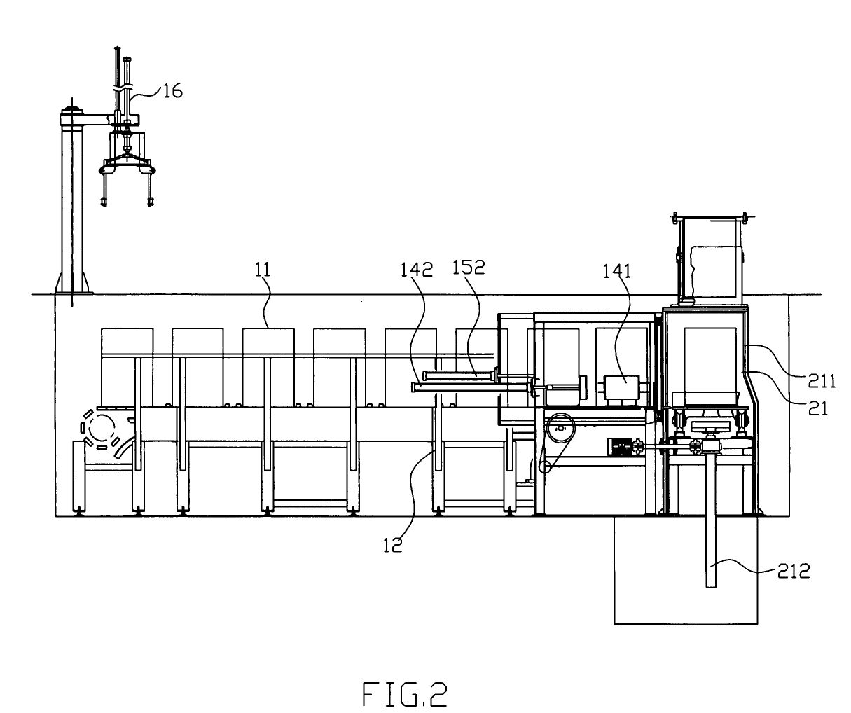

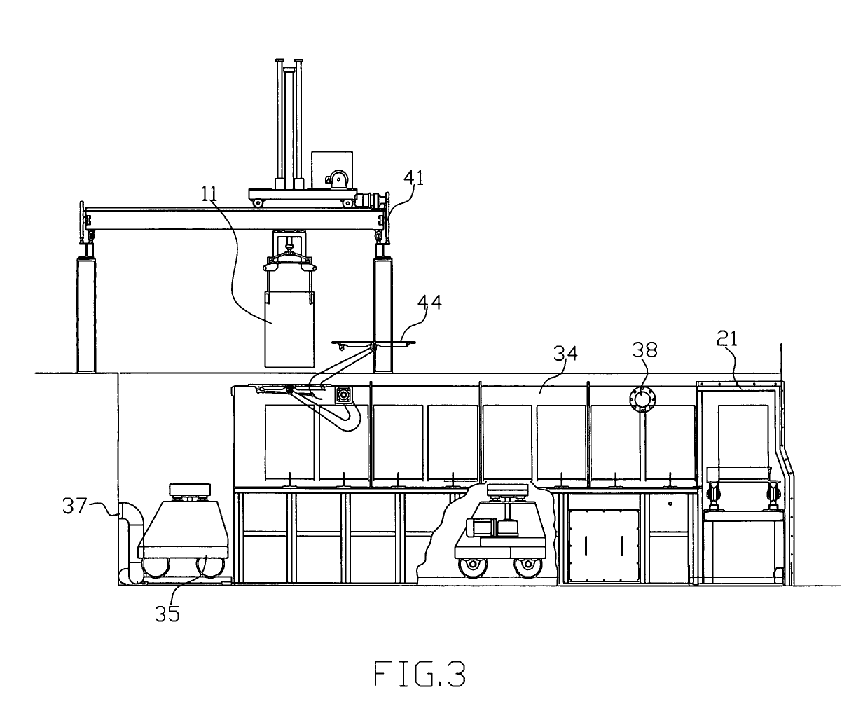

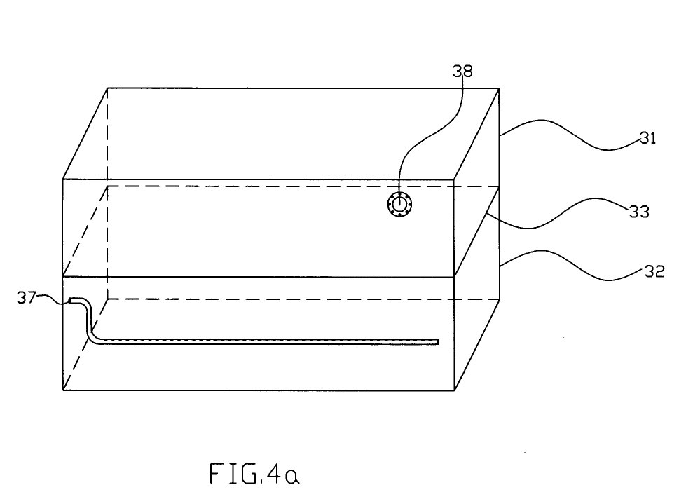

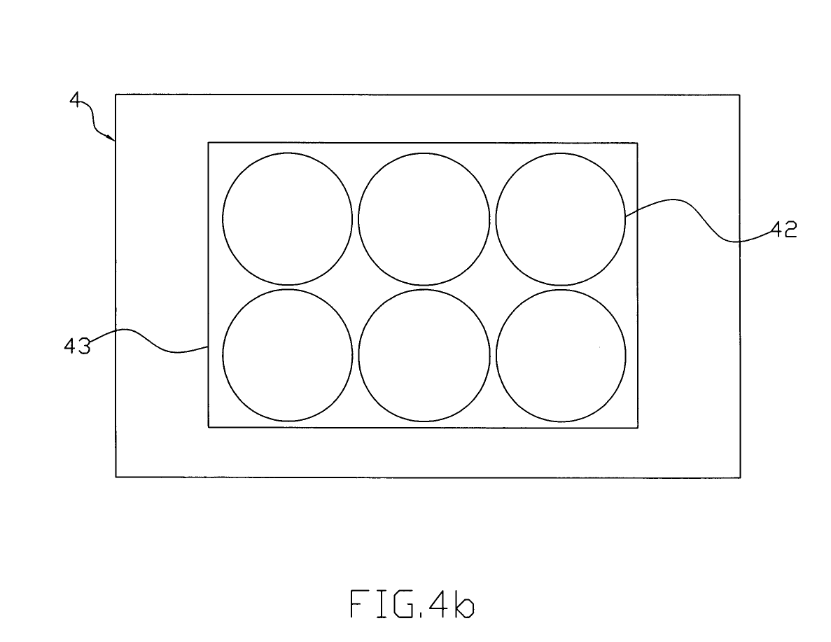

Please refer to FIG. 1 through FIG. 4b, which, according to a preferred embodiment of the present invention, are a top view side views showing a transport unit, a lava-discharge cooling unit, a transport unit and a storage unit; a view showing an air-cooling system of a cooling tunnel; and, a view showing the storage unit. As shown in the figures, a metal bucket 11 for carrying plasma lava is transported by a transport unit 1 to a lava-discharge cooling unit 2 and a cooling tunnel 3 to be cooled down for being stored in a storage unit 4, so that a process for cooling the plasma lava in a plasma furnace is accomplished. By utilizing a hanger 16, which moves along X-axle and Z-axle under a programmable control, the transporting and cooling device for plasma lava according to the present invention hangs a metal bucket 11 and puts it on a conveyer 12 which can bear 7 metal buckets. The conveyer 12 is driven by an electric motor to transport and position the metal bucket 11 at the end of the conveyer 12. And, a first sealing gate 151 is opened while the metal bucket 11 is moved to the front of a first pneumatic rod 141 by the conveyer 12. Then, the first sealing gate 151 is closed and a second sealing gate 152 is opened while the metal bucket 11 is pushed into a bucket pushing room 13 by the first pneumatic rod 141. Then, the second sealing gate 152 is closed and a third sealing gate 153 is opened while the metal bucket 11 is pushed to an elevating plate 212 of a lava-discharge room 21 by the second pneumatic rod 142, where a cooling jacket 211 is deposed at the exterior surface of the lava-discharge room 21. The elevating plate 212 can carry a metal bucket of 1400 kg (kilogram) and the elevating plate 212 has a water-cooling plate on it to be in touch with the bottom of the metal bucket 11 for increasing heat conduction. The elevating plate 212 lifts the metal bucket 11 to be positioned in a cooling steel sheath 213, where the metal bucket 11 is exactly positioned under a lava-discharge tap and is jointed with a joint plate at the lower rim for discharging plasma lava. The lava-discharge room 21 is air-locked by utilizing the third sealing gate 153 and a fourth sealing gate 23. The first, the second, the third and the fourth sealing gates 151, 152, 153, 23 are each made of an sealing gasket with heat resistance to isolate high temperature and made the present invention air-locked. After 5 minutes for discharging plasma lava, the plasma lava in a plasma furnace is flowed into the metal bucket 11 owing to gravity to obtain a metal bucket of 600˜1400 kg and 168 liters (90 percent of 187 liters of the original volume of the metal bucket). When discharging the plasma lava, the metal bucket 11 is impacted at a temperature of 1300˜1600° C. and the metal bucket 11 is cooled down by the cooling steel sheath 213 and the water-cooling plate of the elevating plate 212. There is a gap of 10 nm between the cooling steel sheath 213 and the metal bucket 11 for air to pass through to cool down the plasma lava in the metal bucket 11. The cooling jacket 211, around the exterior surface of the lava-discharge room 21, and the joint plate, a Frange with an opening of 50 cm (centimeter), are formed into a whole for exhausting the off-gas from the metal bucket 11 into a off-gas system.

After discharging the plasma lava and sealing the metal bucket 11 and cooling the temperature of the metal bucket 11 down below 500° C., the elevating plate 212 is lowered down; and, by using a third pneumatic rod 22, the metal bucket 11 is pushed to the cooling tunnel 3 for further cooling down. The cooling tunnel 3 comprises a cooling-water jacket 36 on the wall, a carrying track 34 having a load capacity of 11200 kg for 8 metal buckets, and a transport caravan 35 having a maximum load of 1400 kg. By utilizing the transport caravan 35, the metal bucket 11 is moved on the carrying track 34 in the cooling tunnel 3 seat by seat. A cooling-air entrance 37 is set to connect with an air distribution pipe and a cooling-air exit 38 is set to connect with an exhausting pipe. Hence, by processing air-cooling and water-cooling for 20 hours, the surface temperature of the metal bucket 11 is cooled down below 60° C. The cooling tunnel 3 is divided into an upper space 31 and a lower space 32 with a cooling jacket end-plate 33 between the upper space 31 and the lower space 32 under the carrying track 34, so that radiant heat from the metal bucket 11 in the upper space is prevented from radiating directly to the transport caravan 35 in the lower space. Then, the metal bucket 11 is guarded by two security guiding-shaft to be safely positioned on the carrying track 34 without toppling or falling. The water run in the cooling-water jacket 36 is used to cool down 8 metal buckets and so the temperature of the metal bucket 11 is cooled down from 500° C. to 60° C., while the cooling-air entrance 37 has an air filter (not shown in the figures) and is connected with an air distribution pipe (not shown in the figures); and the cooling-air exit 38 has a prefilter (not shown in the figures) and a High Efficiency Particulate Air-Filter (HEPA) (not shown in the figures) to prevent radioactive pollutant from escaping out with cooling air flowed between the cooling-air entrance 37 and the cooling-air exit 38. The transport caravan 35 comprises a power motor and a positioning brake device; is made of a high-temperature insulation material to prevent from being damaged by high temperature; can be elevated by a brake device for 6 cm (centimeter); has a wheel at the bottom to roll on a skidding track for positioning the metal bucket 11 at a predestined location; and, carries the metal bucket 11 to an exit of the cooling tunnel 3.

After the metal bucket 11 is cooled down to 60° C. and is sealed with a cover, an outlet sealing gate 44 of the cooling tunnel 3 is opened; then, the metal bucket 11 is hanged to a storage bucket 42 of 55 gallons by a programmable positioning hanging device 41, which can move along X-axle, Y-axle and Z-axle. Because the gap between the metal bucket 11 and the storage bucket 42 is only 1.5 cm wide, the positioning done by the positioning hanging device 41 must be accurate. The storage unit 4 comprises a hanging cabinet 43. The hanging cabinet 43 comprises four side surfaces of reinforcing frames, where three of them are fixed while the other one can be actively opened. The hanging cabinet 43 comprises a metal ladder board at the bottom; 6 storage buckets 42, each of which is made of a carbonic steel and comprises a volume of 55 gallons, can be put on the metal ladder board; and, the maximum loading of the hanging cabinet 43 is 5000 kg. Because one of the four surfaces of the hanging cabinet 43 is a door actively opened, the metal ladder board can be forked, lifted and carried out by a lift truck. At the upper rim of each of the four surfaces of the hanging cabinet 43 is deposed a hanging ear for a sky-walking crane to hang the hanging cabinet 43. The present invention processes the discharging of plasma lava and the cooling down of the metal bucket under a thorough monitor with a closed-circuit television; and the present invention has advantages of continuous cooling operation, fewer rotating parts, no environment pollution, etc. Owing to the indirect cooling process, no gas explosion would happen; so, the present invention can be applied in a plasma melting process for radioactive material, where environment detection devices for positioning, temperature, air-pressure, water-pressure, wind volume and wind force are applied in the lava-discharge cooling unit 2 and the cooling tunnel 3 for safe operations.

To sum up, the present invention is a transporting and cooling device for plasma lava, which continuously transports and cools down plasma lava to obtain lava block with no gas explosion under an indirect cooling; comprises fewer rotating parts for transportation; prevents radioactive pollutants from escaping out with an air-locked environment; and, avoids motor of transport caravan being operated under a high temperature.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A transporting and cooling device for plasma lava, comprising:
(a) a transport unit comprising:
(i) a metal bucket,
(ii) a hanger,
(iii) a conveyer,
(iv) a bucket pushing room,
(v) a first pneumatic rod,
(vi) a second pneumatic rod,
(vii) a first sealing gate, and
(viii) a second sealing gate;
(b) a lava-discharge cooling unit comprising:
(i) a lava-discharge room comprising:
(α) a cooling jacket;
(β) an elevating plate; and
(γ) a cooling steel sheath,
(ii) a third pneumatic rod,
(iii) a third sealing gate, and
(iv) a fourth sealing gate;
(c) a cooling tunnel comprising:
(i) a carrying track,
(ii) a transport caravan, and
(iii) a cooling-water jacket;
(d) a storage unit comprising:
(i) a storage bucket,
(ii) a positioning hanging device, and
(iii) a hanging cabinet,
wherein said transport unit moves said metal bucket to said lava-discharge cooling unit with said conveyer; then, in said lava-discharge cooling unit, said metal bucket carries plasma lava and is cooled down; then, said metal bucket is moved and is further cooled down in said cooling tunnel; and, then, said metal bucket is hanged to said storage unit to be stored.

2. The transportation apparatus according to claim 1,
wherein said lava-discharge cooling unit and said cooling tunnel are air-locked devices.

3. The transportation apparatus according to claim 1,
wherein said lava-discharge cooling unit comprises a time of at least 5 minutes for discharging plasma lava.

4. The transportation apparatus according to claim 1,
wherein said cooling tunnel comprises an upper space and a lower space with a cooling jacket end-plate separating said upper space and said lower space;
wherein said cooling tunnel comprises a cooling-air entrance and a cooling-air exit;
wherein said cooling-air entrance has a filter and is connected with an air distribution pipe; and
wherein said cooling-air exit has a prefilter and a High Efficiency Particulate Air-Filter (HEPA).

5. The transportation apparatus according to claim 1,
wherein said conveyer comprises a load capacity of 7 metal buckets.

6. The transportation apparatus according to claim 1,
wherein said hanger is positioned automatically along X-axle and Z-axle under a programmable control.

7. The transportation apparatus according to claim 1,
wherein said first, said second, said third and said fourth sealing gates are each made of a sealing gasket with heat resistance.

8. The transportation apparatus according to claim 1,
wherein said lava-discharge room is air-locked with said cooling jacket, said third sealing gate and said fourth sealing gate.

9. The transportation apparatus according to claim 1,
wherein, after said metal bucket is loaded with said plasma lava, said metal bucket is cooled down for 2 hours in said lava-discharge room to obtain a temperature below 500° C. (centigrade) on surface of said metal bucket; and, then, said metal bucket is cooled down in said cooling tunnel for 20 hours to obtain a temperature below 60° C. on said surface of said metal bucket.

10. The transportation apparatus according to claim 1,
wherein said metal bucket comprises a volume capacity of 168 liters and a load capacity of 600 to 1400 kg (kilogram).

11. The transportation apparatus according to claim 1,
wherein said metal bucket is cooled down in said lava-discharge room having said cooling jacket and a cooling plate on said elevating plate; and
wherein said metal bucket comprises a gap of 10 millimeter to said cooling jacket when discharging plasma lava.

12. The transportation apparatus according to claim 1,
wherein said elevating plate comprises a load capacity for said metal bucket of 1400 kg.

13. The transportation apparatus according to claim 1,
wherein said carrying track comprises a length to deposit 8 metal buckets; and
wherein said carrying track comprises a load capacity of 11200 kg.

14. The transportation apparatus according to claim 1,
wherein said transport caravan comprises a maximum load capacity of 1400 km;
wherein said transport caravan comprises a power motor and a positioning brake device; and
wherein said transport caravan is made of a high-temperature insulation material.

15. The transportation apparatus according to claim 1,
wherein said metal bucket comprises a gap of 1.5 centimeters to said storage bucket.

16. The transportation apparatus according to claim 1,
wherein said storage bucket is a carbonic steel bucket of 55 gallons.

17. The transportation apparatus according to claim 1,
wherein said hanging cabinet comprises a bottom surface having a metal ladder board;
wherein said metal ladder board comprises a maximum loading of 5000 km; and
wherein said hanging cabinet comprises side surfaces of reinforcing frames connected with said bottom surface.
